(19) United States
(12) Patent Application Publication
(10) Pub. No.: US 2016/0356417 A1
(43) Pub. Date: Dec. 8, 2016

(54) ADJUSTABLE APPARATUS TO SUPPORT DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: YONG-CHANG FAN, Wuhan (CN); SAN-YONG YANG, Wuhan (CN)

(21) Appl. No.: 14/754,140

(22) Filed: Jun. 29, 2015

(30) Foreign Application Priority Data
Jun. 2, 2015 (CN) 201510294516.6

(51) Int. Cl. F16M 13/02; F16B 2/12

(52) U.S. Cl. CPC F16M 13/022; F16B 2/12; F16M 2200/063

(57) ABSTRACT

An adjustable apparatus which supports and fixes an electronic device includes a mounting device and a moving device. The moving device includes at least one first rod, at least one second rod, and a rotating member. The at least one first rod is rotatably connected with the mounting device and the rotating member. The at least one second rod is connected with the rotating member and the electronic device. The at least one first rod and the at least one second rod form a rotatable planar linkage. The moving device can transform from a folded state to an extended state to adjust the height and orientation of the electronic device and its distance from a user.

### CROSS-REFERENCE TO RELATED APPLICATIONS

This application claims priority to Chinese Patent Application No. 201510294516.6 filed on Jun. 2, 2015, the contents of which are incorporated by reference herein.

### FIELD

The subject matter herein generally relates to support structures and in at least one implementation support structures for display devices.

### BACKGROUND

An electronic device such as a flat screen display includes an adjustable apparatus to support the flat panel display on a platform. When the flat panel display is used, it needs to be positioned on a desk. An adjustable apparatus usually includes a stand and a supporting column coupled to the stand. The stand is configured to be secured to the platform, and the supporting column is configured to be mounted to a shell of the display to support the display.

### BRIEF DESCRIPTION OF THE DRAWINGS

Implementations of the present technology will now be described, by way of example only, with reference to the attached figures.

FIG. 1 is an exploded, isometric view of one embodiment of an adjustable apparatus.

FIG. 2 is an assembled, isometric view of the adjustable apparatus of FIG. 1.

FIG. 3 is an isometric view of the adjustable apparatus of FIG. 1, the adjustable apparatus being in an extended state.

FIG. 4 is similar to FIG. 3, the adjustable apparatus being in a folded state.

### DETAILED DESCRIPTION

It will be appreciated that for simplicity and clarity of illustration, where appropriate, reference numerals have been repeated among the different figures to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

The present disclosure is described in relation to an adjustable apparatus. The adjustable apparatus supports and fixes an electronic device. The adjustable apparatus can be fixed or coupled to another article of furniture. The adjustable apparatus includes a mounting device and a moving device. The moving device can support the electronic device. The moving device includes at least one first rod, at least one second rod, and a rotating member. The at least one first rod is rotatably connected with the mounting device and the rotating member. The at least one second rod is connected with the rotating member and the electronic device. The at least one first rod and the at least one second rod are a planar linkage, able to rotate around the rotating member in a same plane. The moving device can transform from a folded state to an extended state to adjust the position of the electronic device.

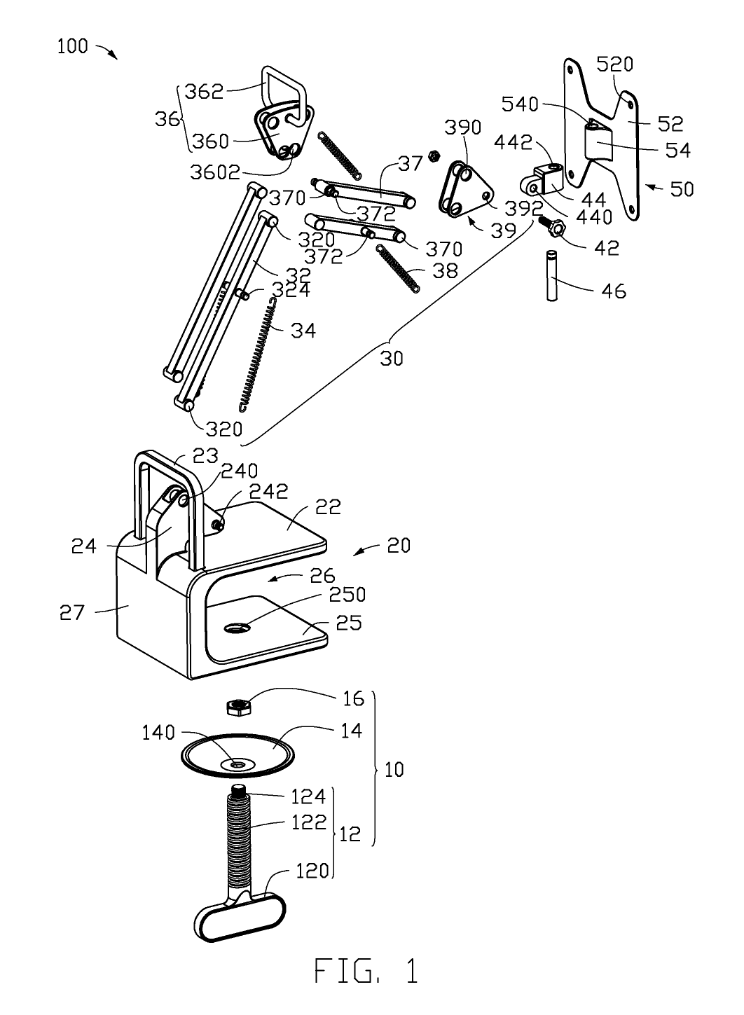

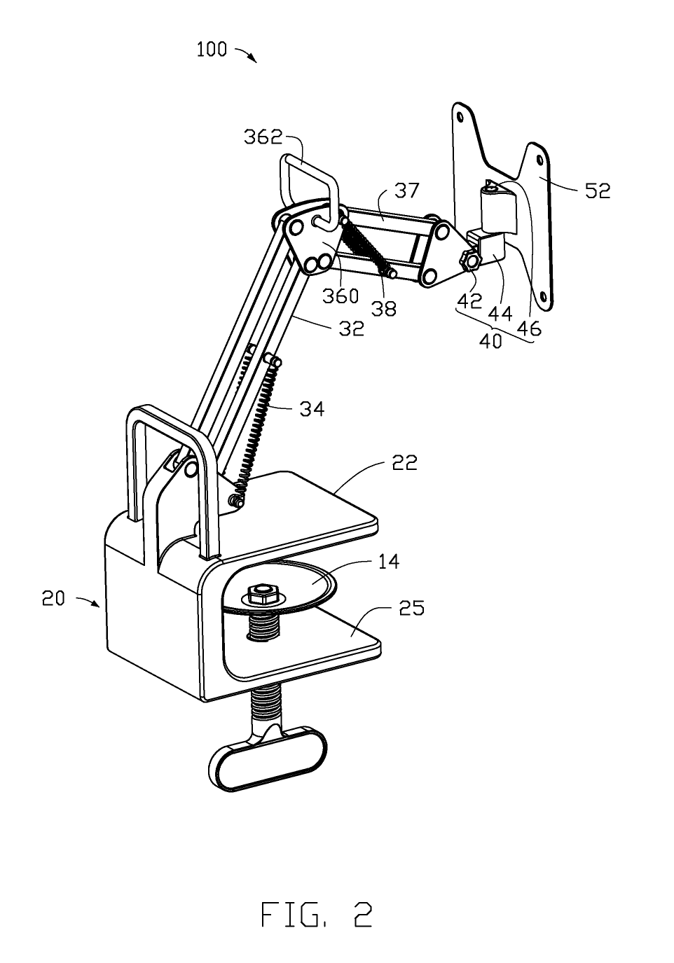

FIGS. 1-2 illustrate one embodiment of an adjustable apparatus 100. The adjustable apparatus 100 includes an adjusting device 10, a mounting device 20, a moving device 30, an operating structure 40, and a mounting plate 50.

The adjusting device 10 includes a grip 12, a clamping plate 14, and a nut 16. The grip 12 includes an operation tab 120, a post 122, and a fixing end 124. The post 122 extends from the operation tab 120. The fixing end 124 is located on one end of the post 122 away from the operation tab 120. Each of the post 122 and the fixing end 124 includes external threads. The clamping plate 14 defines a fixing hole 140. In one embodiment, the clamping plate 14 can be substantially circular, and the fixing hole 140 is defined in the centre of the circle that is defined by the clamping plate 14. The centre of the clamping plate 14 is recessed.

The mounting device 20 includes a first plate 22, a stopper portion 23, a connecting portion 24, a second plate 25, and a third plate 27. The first plate 22 and the second plate 25 extend from opposite ends of the third plate 27. In one embodiment, the first plate 22 can be substantially parallel to the second plate 25. The third plate 27 can be substantially perpendicular to the first plate 22 and the second plate 25. The first plate 22, the second plate 25, and the third plate 27 cooperatively define a mounting space 26. The stopper portion 23 and the connecting portion 24 extend from one end of the first plate 22 near the third plate 27. In one embodiment, the stopper portion 23 can be substantially U-shaped. The connecting portion 24 is located within the stopper portion 23. The connecting portion 24 defines a plurality of first connecting holes 240. The connecting portion 24 includes two first fixing posts 242. The second plate 25 defines a screw hole 250.

The moving device 30 includes two first rods 32, two first elastic members 34, a rotating member 36, two second rods 37, two second elastic members 38, and a connecting member 39. Each first rod 32 includes two first rotating portions 320. The two first rotating portions 320 are located on two ends of the first rod 32. One of the two first rods 32 includes two second fixing posts 324. The two second fixing posts 324 are located on two sides of the first rod 32. A length of the each first rod 32 is the same. The rotating member 36 includes a body 360 and a handle 362 fixed to the body 360. The body 360 defines four second connecting holes 3602. In one embodiment, a connecting line of the four second connecting holes 3602 can be substantially an isosceles trapezoid. Each second rod 37 includes two second rotating portions 370. The two second rotating portions 370 are located on two sides of the second rod 37. Two third fixing posts 372 extend from middle of one of the two second rods 37. Two third fixing posts 372 extend from one end of another second rod 37. The connecting member 39 defines two third connecting holes 390 and a shaft hole 392. In one embodiment, a connecting line of the two third connecting holes 390 and the shaft hole 392 can be substantially an isosceles triangle.

The operating structure 40 includes a first shaft 42, an operating knuckle 44, and a second shaft 46. A first locking hole 440 is defined in a first end of the operating knuckle 44. A second locking hole 442 is defined in a second opposite end of the operating knuckle 44. In one embodiment, the first locking hole 440 can be substantially perpendicular to the second locking hole 442.

The mounting plate 50 includes a main portion 52 and a protrusion 54. The protrusion 54 extends from the main portion 52. The main portion 52 defines a plurality of mounting holes 520. The protrusion 54 defines a third locking hole 540.

The post 122 of the grip 12 is within the screw hole 250 of the second plate 25. The clamping plate 14 is mounted on the fixing end 124 of the grip 12 via the fixing hole 140. The nut 16 is fixed to the fixing end 124 to fix the clamping plate 14 to the grip 12. The two first rotating portions 320 of the two first rods 32 are rotatably engaged in the plurality of first connecting holes 240. A first end of each of the two first elastic members 34 is fixed to one of the two first fixing posts 242. A second end of each of the two first elastic members 34 is fixed to one of the two second fixing posts 324. The four second connecting holes 3602 are rotatably engaged in the two first rotating portions 320 and two second rotating portions 370. Two ends of each second elastic member 38 are fixed to the two third fixing posts 372 of the two second rods 37. The two second rotating portions 370 of the two second rods 37 are rotatably engaged in the two third connecting holes 390 of the connecting member 39. The first shaft 42 can extend through the shaft hole 392 to be engaged in the first locking hole 440 to rotatably fix the operating knuckle 44 to the connecting member 39. The second shaft 46 is received in the third locking hole 540 and the second locking hole 442. The first shaft 42 can be substantially perpendicular to the second shaft 46. The two first rods 32 can be substantially parallel to each other. The two second rods 37 can be substantially parallel to each other.

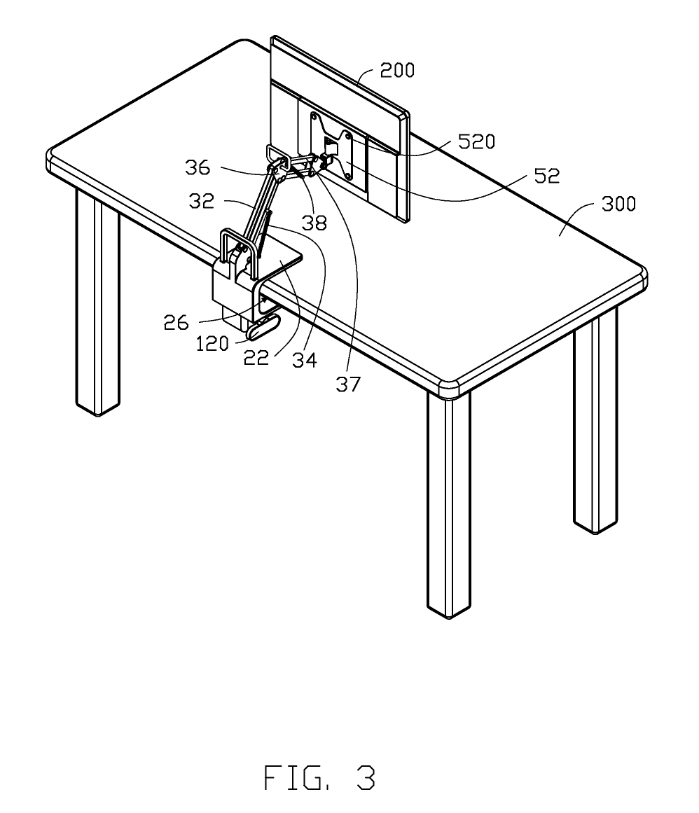

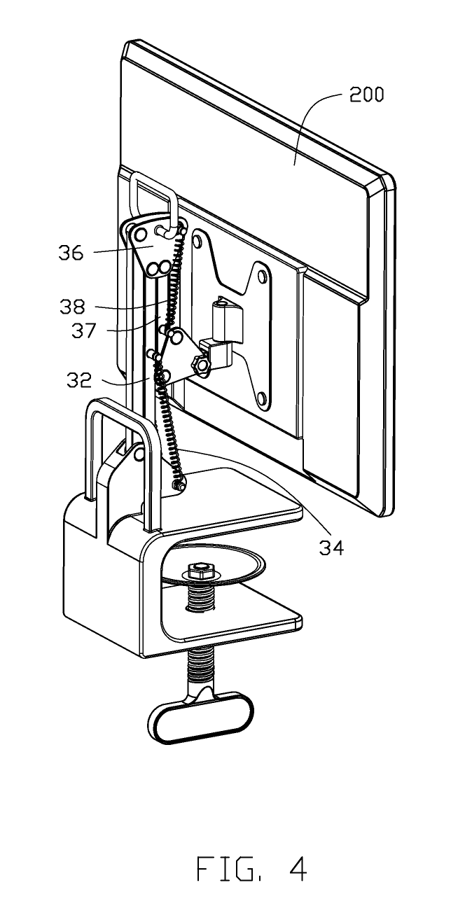

FIGS. 3-4 illustrate isometric views of the adjustable apparatus 100 in different working states. The first plate 22 of the mounting device 20 is located on a surface of a desk 300. An edge of the desk 300 is received in the mounting space 26. The clamping plate 14 is moved towards the desk 300 until the desk 300 is clamped between the first plate 22 and the clamping plate 14. The main portion 52 is fixed to an electronic device 200 via the plurality of mounting holes 520. The moving device 30 is in an extended state.

When the position of the electronic device 200 needs to be adjusted, the moving device 30 can transform from the extended state to a folded state. The moving device 30 is rotated relative to the mounting device 20 until it abuts the stopper portion 23. The two first rods 32 and the two second rods 37 are rotated in a plane relative to the rotating member 36. When the two first rods 32 are rotated, the two first rods 32 can be substantially parallel to each other. As a distance between the two first rods 32 becomes small. An angle between the electronic device 200 and the desk 300 can be adjusted by the moving device 30. The mounting plate 50 is rotated relative to the operating structure 40 to adjust an angle of the electronic device 200. The operating knuckle 44 is rotated relative to the connecting member 39 to adjust the angle of the electronic device 200.

The embodiments shown and described above are only examples. Many details are often found in the art such as other features of an adjustable apparatus. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An adjustable apparatus comprising:
a moving device comprising:
a rotating plate;
at least one first rod coupled to the rotating plate; and
at least one second rod rotatably coupled to the at least one first rod by the rotating member;
a mounting device rotatably coupled to the moving device; and
wherein the moving device is rotatable relative to the mounting device between a folded state and an extending state, when the moving device is located in the folded state, the at least one first rod abuts and is substantially parallel to the at least one second rod, and when the moving device is located in the extending state, the at least one first rod and the at least one second rod define an angle therebetween.

2. The adjustable apparatus of claim 1, wherein the at least one first rod comprises two first rods, the at least one second rod comprises two second rods, and the two first rods and the two second rods are in a same plane.

3. The adjustable apparatus of claim 2, wherein the two first rods are substantially parallel to each other.

4. The adjustable apparatus of claim 2, wherein the two second rods are substantially parallel to each other.

5. The adjustable apparatus of claim 2, wherein the rotating member defines four second connecting holes, the two first rods and the two second rods are rotatably engaged in the four second connecting holes, and a connecting line of the four second connecting holes is substantially a isosceles trapezoid.

6. The adjustable apparatus of claim 5, wherein the two first rods are rotatably engaged in a first side of the isosceles trapezoid, and the two second rods are rotatably engaged in a second opposite side of the isosceles trapezoid.

7. The adjustable apparatus of claim 2, wherein the moving device further comprises a first elastic member and a second elastic member, one end of the first elastic member is fixed to the mounting device, an opposite end of first elastic member is fixed to the first rod, one end of each second elastic member is fixed to one of the two second rods, and one opposite end of each second elastic member is fixed to another second rod.

8. The adjustable apparatus of claim 2 further comprising an operating knuckle, wherein the moving device further comprises a connecting member, the connecting member defines two third connecting holes and a shaft hole, the two second rods are rotatably engaged in the two third connecting holes, and the operating knuckle is rotatably engaged in the shaft hole.

9. The adjustable apparatus of claim 8, wherein a connecting line of the two third connecting holes and the shaft hole is substantially isosceles triangle.

10. The adjustable apparatus of claim 8 further comprising a mounting plate, wherein the connecting member is rotatably connected to one end of the operating knuckle via a first shaft, the mounting plate is rotatably connected to another end of the operating knuckle via a second shaft, and the first shaft is substantially perpendicular to the second shaft.

11. The adjustable apparatus of claim 1 further comprising an adjusting device, wherein the adjusting device comprises a grip and a clamping plate fixed to one end of the grip, the mounting device comprises a first plate, and the grip is rotatable relative to the mounting device to adjust a distance between the clamping plate and the first plate.

12. An adjustable apparatus comprising:
a moving device comprising at least one first rod, at least one second rod, and a rotating member, and the at least one first rod rotatably coupled to the at least one second rod by the rotating member;
a mounting device rotatably fixed to the moving device; and
wherein the moving device is configured to support an electronic device, the at least one first rod is rotatable about a first axis relative to the mounting device, and the at least one second rod is rotatable relative to a second axis that is substantially parallel to the first axis to adjust an angle of the electronic device.

13. The adjustable apparatus of claim 12, wherein the at least one first rod comprises two first rods, the at least one second rod comprises two second rods, and the two first rods and the two second rods are in a same plane.

14. The adjustable apparatus of claim 13, wherein the two first rods are substantially parallel to each other.

15. The adjustable apparatus of claim 13, wherein the two second rods are substantially parallel to each other.

16. The adjustable apparatus of claim 13, wherein the rotating member defines four second connecting holes, the two first rods and the two second rods are rotatably engaged in the four second connecting holes, and a connecting line of the four second connecting holes is substantially a isosceles trapezoid.

17. The adjustable apparatus of claim 16, wherein the two first rods are rotatably engaged in a first side of the isosceles trapezoid, and the two second rods are rotatably engaged in a second opposite side of the isosceles trapezoid.

18. The adjustable apparatus of claim 13, wherein the moving device further comprises a first elastic member and a second elastic member, one end of the first elastic member is fixed to the mounting device, an opposite end of first elastic member is fixed to the first rod, one end of each second elastic member is fixed to one of the two second rods, and one opposite end of each second elastic member is fixed to another second rod.

19. The adjustable apparatus of claim 13 further comprising an operating knuckle, wherein the moving device further comprises a connecting member, the connecting member defines two third connecting holes and a shaft hole, the two second rods are rotatably engaged in the two third connecting holes, and the operating knuckle is rotatably engaged in the shaft hole.

20. The adjustable apparatus of claim 12 further comprising an adjusting device, wherein the adjusting device comprises a grip and a clamping plate fixed to one end of the grip, the mounting device comprises a first plate, and the grip is rotatable relative to the mounting device to adjust a distance between the clamping plate and the first plate.
